(19) United States
(12) Patent Application Publication
(10) Pub. No.: US 2024/0139561 A1
(43) Pub. Date: May 2, 2024

(54) FLAME RETARDANT POLYURETHANE COATING FOR BELT CONVEYOR ROLLERS

(71) Applicant: SOMMA COMÉRCIO DE EQUIPAMENTOS INDUSTRIAIS LTDA., Sao Paulo (BR)

(72) Inventor: Eliana Aparecida Reis de Souza, Sao Paulo (BR)

(21) Appl. No.: 18/275,502

(22) PCT Filed: Jan. 31, 2022
(86) PCT No.: PCT/BR2022/050029

§ 371 Date: Aug. 2, 2023

(30) Foreign Application Priority Data
Feb. 3, 2021 (BR) 2020210020380
Jul. 6, 2021 (BR) 2020210133088
Sep. 30, 2021 (BR) 2020210196845

(51) Int. Cl. A62C 3/00; B65G 39/02

(52) U.S. Cl. CPC A62C 3/002; B65G 39/02; B65G 2207/22

(57) ABSTRACT

The invention relates to a roller composed of a shaft (1), which comprises a metal housing (2), a machined metal bearing (3) that houses bearings, further, by the roller having a flame retardant polyurethane coating (4) UL94 V-0, impact energy sink. Nevertheless, it comprises a labyrinth top seal (5) and retainer seal (6) retaining contaminants or moisture, being fixed in the machined metal bearing (3). It also has a bearing (7) fixed to the machined metal bearing (3) and fixed by means of an elastic ring (8). The elastic ring (8) keeps the bearing in the predetermined position inside the machined metal bearing (3), in addition to being fixed to the machined metal bearing (3) and/or to the shaft (1). In this way, belt conveyor rollers, whether impact, return, load, turning, aligner or tensioner rollers, are used in the belt conveyors and applied along the entire length of the conveyor, whose function is to allow the slide of the belt on the conveyor, enabling the transport of the material. The present coating is applied on the outside of the roller housing, with the objective of protecting the housing against wear caused by friction between the belt and the roller.

### FIELD OF INVENTION

The present patent application refers to an unprecedented UL94 V-0 flame retardant polyurethane coating, certified by means of a flammability test, based on the UL94 standard (standard for flammability safety of polymeric materials), and classified as V-0. In this way, belt conveyor rollers, whether impact, return, load, turning, aligner or tensioner rollers, are used in the belt conveyors and applied along the entire length of the conveyor, whose function is to allow the slide of the belt on the conveyor, enabling the transport of the material. The present coating is applied on the outside of the roller housing, with the objective of protecting the housing against wear caused by friction between the belt and the roller.

### Problem to be Solved

Currently, the coating of the belt conveyor rollers are made from materials of various types, but, until then, all the materials used are flammable, which generates a great risk of serious accidents, with the possibility of loss of the entire conveyor. The roller with flammable coating is used by the market in general, due to its low cost, however, with the increase in the capacity of the conveyors the rollers became more required and, with this, the number of fire occurrences in conveyors originated in the rollers increased.

### PROPOSED SOLUTION

Given the above, the present inventor, researcher and scholar in the field, has developed a flame retardant polyurethane coating for belt conveyor rollers. The higher capacity conveyor belts have a high acquisition cost, and therefore the possibility of applying a flame retardant polyurethane coating to the rollers was seen, which despite having a higher cost, significantly increased safety in the field. The flame retardant polyurethane coating allows the rollers to work in any demanding condition, without the risk of catching fire, whether due to roll failure, wear or any other reason.

### CURRENT STATE OF THE ART

However, it is known from the current state of the art the document BR112014002921-0, filed on Aug. 13, 2012, describes a conveyor roller, with motorized drum, which has a drum housing with a motor within it and an end cap of a determined diameter with an end cap recess. An end cap removing tool has an outer circumferential geometry with a larger diameter and a tool recess. The tool recess complements the end cap recess. A joint cable has a cross-sectional geometry that corresponds to the combination of the end cap recess and the tool recess. An entrance allows access to the channel and a flexible member is installed through it to occupy the channel. A percussion hammer applies an axially outwardly facing force whereby the end cap is urged axially outwardly in response to the outwardly facing force imprinted on the end cap arrangement by means of the flexible member. The scavenger tool may alternatively have a circumferential spiral geometry that is configured to engage an outer circumferential spiral geometry of the end cap.

Prior art is cited only to compose the current state of the art, since it brings an inventive concept totally distinct from the present invention.

### ADVANTAGES OF THE INVENTION

The present invention has advantages related to significantly increasing the safety of the conveyor rollers. In addition, it fights the fire risk of said rollers, since the coating, the present invention, is a UL94 V-0 flame retardant polyurethane coating, certified by means of a flammability test, based on the UL94 standard (standard for flammability safety of polymeric materials), and classified as V-0. Still, the present coating is applied on the outside of the roller housing, with the objective of protecting the housing against wear caused by friction between the belt and the roller.

### DESCRIPTION OF THE DRAWINGS

To aid in the understanding, the following illustrations are attached:

FIG. 1: shows the front view of a roller with cutting in the bearing region;

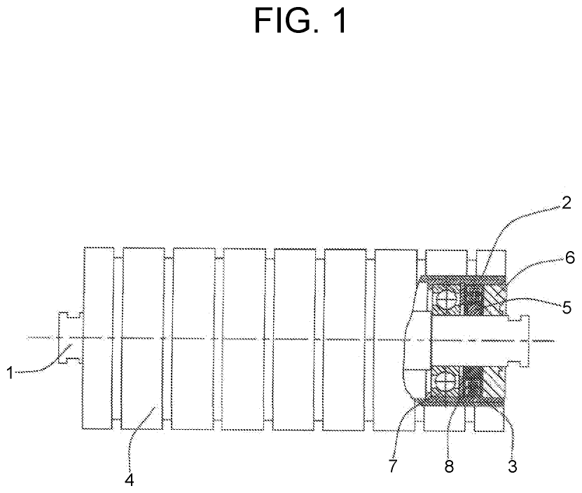

FIG. 2: shows the side view of a roller with the UL94 V-0 flame retardant polyurethane coating

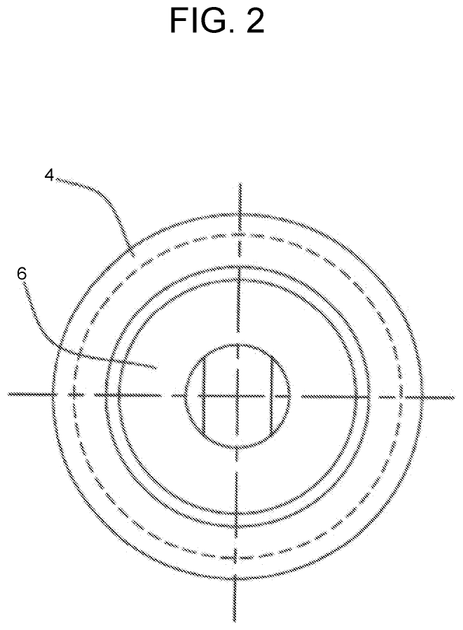

FIG. 3: shows the side view of a roller with the UL94 V-0 flame retardant polymer coating;

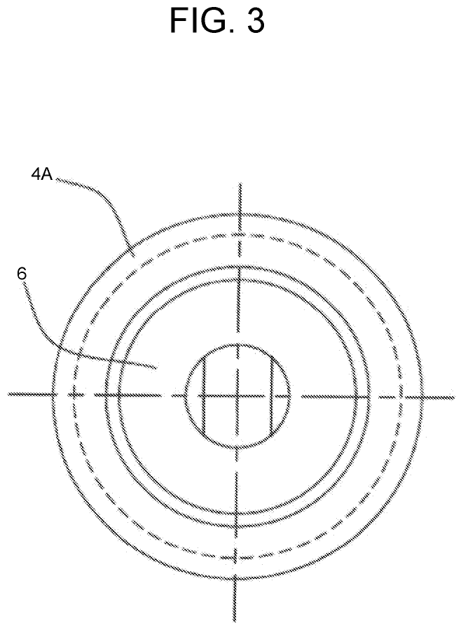

FIG. 4: shows the side view of a roller with the UL94 V-0 flame retardant/self-extinguishing engineering plastic coating;

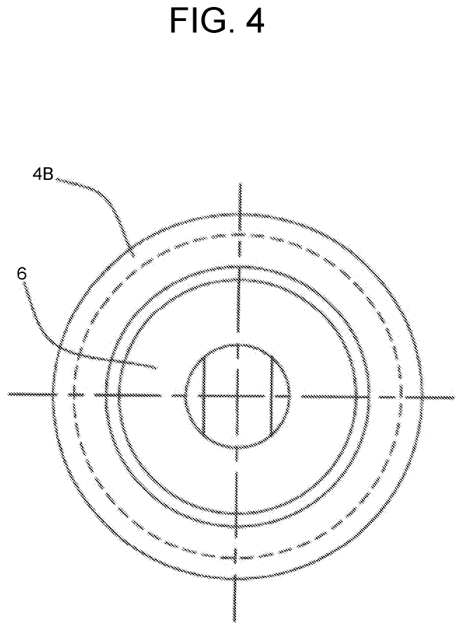

FIG. 5: shows the side view of a roller with the UL94 V-0 flame retardant rubber coating.

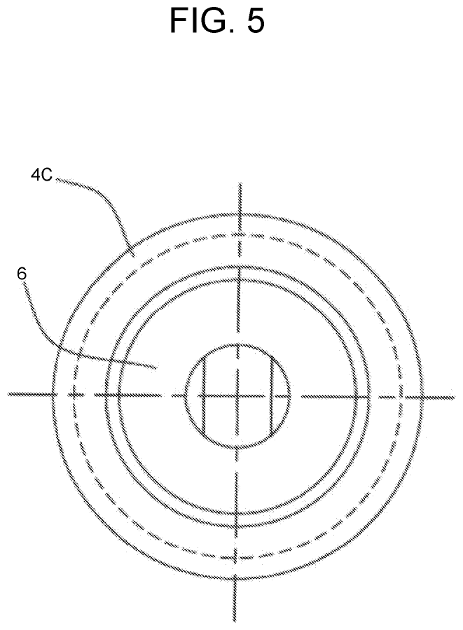

### DETAILED DESCRIPTION OF THE INVENTION

The invention consists of a roller composed of a shaft (1), a metal housing (2), a machined metal bearing (3), still by a flame retardant polyurethane coating (4) UL94 V-0, a labyrinth top seal (5) and retainer seal (6), with bearing (7) and elastic ring (8). However, they are elements that make up the entire structure of the roller.

In particular, the shaft (1) is the structure responsible for supporting the components of the roller and making the connection between said roller and the roller support, which in turn is fixed to the belt conveyor. The shaft (1) is made of carbon steel, usually SAE1020 or 1045. On the shaft (1), the internal bearing races are fixed, allowing the metal housing (2) to rotate freely. The roller is also responsible for supporting all loading caused by the weight of the belt and the material that is on the belt.

The machined metal bearing (3) is the structure responsible for receiving the kinetic energy from the housing and transmitting it to the bearings. In addition, the machined metal bearing (3) has the responsibility to house the bearings.

The flame retardant polyurethane coating (4) is the component that is fixed to the housing and directly in contact with the conveyor belt. The flame retardant polyurethane coating (4) is the sacrificial material that has the function of protecting the metal housing (2) of the roller against friction wear with the conveyor belt, allowing longer roller life. In addition, because it is malleable, the flame retardant polyurethane coating (4) has the function of dissipating the impact energy of the material transported when falling on the stream in the transfer regions.

The labyrinth seal (5) can be composed of machined metal bearing (3) or plastic and has the function of retaining contaminants or moisture so that they do not reach the bearings. The labyrinth seal (5) is the second protective layer for the bearings and is fixed to the machined metal bearing (3).

The retainer seal (6) can be composed of plastic, metal or metallic material coated in rubber and has the function of retaining contaminants or moisture so that they do not reach the bearings. The retainer seal (6) is the first protective layer for the bearings and is fixed to the machined metal bearing (3).

The bearing (7) is the element responsible for loading and supporting the load acting on the roller, facilitating and supporting the rotating function of the housing. The bearing (7) is the element that gives the roller the possibility to rotate. The bearings present in the roller are in the metallic bearing and fixed by means of an elastic ring (8).

The elastic ring (8) is the element responsible for keeping the bearing in the predetermined position inside the machined metal bearing (3), and can be fixed directly to the machined metal bearing (3) and/or to the shaft (1).

In a second embodiment, the flame retardant polyurethane coating (4) UL94 V-0, which is the component that is fixed to the housing and directly in contact with the conveyor belt, whose function is to protect the metal housing (2) of the roller against frictional wear with the conveyor belt, allowing longer roller life, in addition to dissipating the impact energy of the material transported when falling over the belt in the transfer regions, can be made in the form of a flame retardant polymer coating (4A) UL94 V-0. In a third embodiment, it may be manufactured in the form of a flame retardant/self-extinguishing engineering plastic coating (4B) UL94 V-0. Nonetheless, in a fourth embodiment, it may be made in (4C) UL94 V-0 flame retardant rubber coating, impact energy sink.

1. FLAME RETARDANT POLYURETHANE COATING FOR BELT CONVEYOR ROLLERS consists of a roller composed of a shaft (1), wherein a metal housing (2), a machined metal bearing (3) that houses bearings; also, by the roller having a flame retardant polyurethane coating (4) impact energy sink; by the labyrinth top seal (5) and retainer seal (6) retaining contaminants or moisture, being fixed to the machined metal bearing (3); still, by having a bearing (7) fixed to the machined metal bearing (3) and fixed by means of an elastic ring (8); by the elastic ring (8) keep the bearing in the predetermined position inside the machined metal bearing (3), and be fixed to the machined metal bearing (3) and/or to the shaft (1).

2. FLAME RETARDANT POLYURETHANE COATING FOR BELT CONVEYOR ROLLERS according to claim 1, in a second embodiment, wherein having the roller with flame retardant polymer coating (4A) UL94 V-0.

3. FLAME RETARDANT POLYURETHANE COATING FOR BELT CONVEYOR ROLLERS according to claim 1, in a third embodiment, wherein having the roller with flame retardant/self-extinguishing engineering plastic coating (4B) UL94 V-0.

4. FLAME RETARDANT POLYURETHANE COATING FOR BELT CONVEYOR ROLLERS according to claim 1, in a fourth embodiment, wherein having the roller with flame retardant rubber coating (4C) UL94 V-0.
